(19) United States
(12) Patent Application Publication
(10) Pub. No.: US 2003/0020934 A1
(43) Pub. Date: Jan. 30, 2003

(54) Color region compressing method

(76) Inventor: Yukihiro Nishida, Chikushino-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/197,419

(22) Filed: Jul. 18, 2002

(30) Foreign Application Priority Data
Jul. 24, 2001 (JP) 2001-222907

(51) Int. Cl. B41J 1/00

(52) U.S. Cl. 358/1.9

(57) ABSTRACT

A color region compressing method is provided which is capable of reproducing more desirable color by flexibly changing a shape of a compression function according to color to widen a color reproduction range. This color region compressing method for compressing a lightness and/or chroma of an input color to within an output color reproduction region includes the steps of determining by function parameters the compression function for the compression of the lightness and/or chroma of the input color to within the output color reproduction region, and changing the function parameters according to a hue and/or lightness of color.

### BACKGROUND OF THE INVENTION

### Field of the Invention

The present invention relates to a color region compressing method for use in a color reproduction apparatus such as a color printer and a color copying unit.

Recently, as computers and color printers become popular, many color images have been treated in offices and homes.

Although an image is desired to be printed as a color print having the same color as that of the image which the color display is displaying, the color printer generally has output of a narrow color reproduction region as compared with the color display, and thus is required to print with a different color from the actually displayed one on the screen. FIG. 10 shows the comparison between a display color region and a printer color region. A color included in the display color region but out of the printer color region (as indicated by the small white circle ∘) must be moved to a color (the small black circle ●) within the printer color region.

There is a technique for compressing the color region in order to minimize the difference between the displayed color and printed color images. FIG. 11 shows an example of the conventional color region compression. In FIG. 11, the ordinate indicates the lightness (L), and the abscissa the chroma (Chr). The solid lines respectively represent the color region limit (Gdisp) of a display and that (Gprint) of a printer. In this case, the color region limit (Gdisp) of the display is also required to be compressed in the lightness direction so that the small white circle of the display can be coincident with the small black circle of the printer, but the color region limit (Gdisp) of the display shown in FIG. 11 is already compressed in the lightness direction. The broken line indicates the color region limit of the display before being compressed in the lightness direction.

Only the chroma is changed with the lightness and a hue is kept constant in order for the color region of the display to be mapped on the color reproduction region of the printer. FIG. 12 shows an example of the conventional chroma compression function. This function is shown on the abscissa of display chroma and the ordinate of print chroma. Cdmax and Cpmax represent the maximum chromas of the display and the printer at those constant lightness and hue. The colors at the same lightness/hue can be confined within the color region of the printer by this function. FIG. 13 shows another example of the conventional color region compression. In FIG. 13, compressing is made so that the color of the small white circle (∘) can be moved to the small black circle (●), and the small white triangle (∇) to the small black triangle (▾). At any different lightness/hue, the compression can be made by providing the maximum chromas of the display and the printer at that lightness/hue.

There is another method in which compression is made toward a certain point (∘) on zero chroma axis with only hue kept constant, and both chroma and lightness are changed. FIG. 14 shows still another example of the conventional color region compression. FIG. 15 shows an example of the conventional chroma compression function. The compression is made by use of the compression function of FIG. 15 so that the color of white circle (∘) can be moved to the position of black circle (●), and the white triangle (∇) to the black triangle (▾) as shown in FIG. 14, similar to the case of FIG. 13. In the color region compression and compression function of FIGS. 14 and 15, the intersections of the straight line drawn from point (∘) to the compressed color with the display color region limit Gdisp and with the printer color region limit Gprint are represented by Gdx and Gpx, respectively, and the distances S from (∘) to Gdx and Gpx by Sdmax and Spmax, respectively.

### SUMMARY OF THE INVENTION

The compression functions of FIGS. 12 and 15 are generally applied, but when different-shape compression functions are used depending on color (hue), the actual printed image sometimes becomes closer to the displayed image. In these conventional color region compressing methods, since the chroma and lightness are compressed fixedly for a constant hue/lightness, a desired color range cannot be attained.

It is an object of the invention to provide a color region compressing method capable of reproducing more desirable color by flexibly changing the shape of the compression function according to color (hue) to widen the color reproduction range.

According to the invention, in order to solve the above problem, there is provided a color region compressing method for compressing the lightness and/or chroma of an input color to within an output color reproduction region, including the steps of determining by function parameters a compression function for the compression of the lightness and/or chroma of the input color to within the output color reproduction region, and changing the function parameters according to the hue and/or lightness of color.

According to an aspect of the invention in claim 1, there is provided a color region compressing method for compressing the lightness and/or chroma of an input color to within an output color reproduction region, including the steps of determining by function parameters a compression function for the compression of the lightness and/or chroma of an input color to within an output color reproduction region, and changing the function parameters according to the hue and/or lightness of color. Thus, since the shape of the compression function can be flexibly changed according to the hue or lightness, the color reproduction range after the color region compression can be expanded, leading to sufficient color reproduction.

According to another aspect of the invention in claim 2, there is provided the above method, wherein the function parameters are determined for N points (N is an integer of 1 or above) where the hue and/or lightness differs, and the parameters for other points different from the N hue/lightness points are determined by interpolation between the N-point function parameters. Thus, since the shape of the compression function for a finite number of colors within a color space can be flexibly changed according to the hue and/or lightness, the color reproduction range after the color region compression can be expanded, thus leading to full color reproduction.

According to another aspect of the invention in claim 3, there is provided the above method, wherein the function parameters include a parameter for expressing the degree of gradient of the function. Thus, since the gradient of the compression function can be changed according to the hue or lightness, the color reproduction range after the color region compression can be expanded, thus leading to sufficient color reproduction.

According to another aspect of the invention in claim 4, there is provided the above method, wherein the function parameters include a parameter for determining the magnitude of the saturation point of the function. Thus, since the magnitude of the saturation point of the compression function can be changed according to the hue or lightness, the color reproduction range after the color region compression can be expanded, thus leading to satisfactory color reproduction.

According to another aspect of the invention in claim 5, there is provided the above method, wherein the function parameters include a parameter for expressing the degree of nonlinearity of the function. Thus, since the degree of nonlinearity of the compression function can be changed according to the hue or lightness, the color reproduction range after the color region compression can be expanded, thus leading to enough color reproduction.

According to another aspect of the invention in claim 6, there is provided a color converting apparatus for making color conversion by using the above method. Thus, since the shape of the compression function can be flexibly changed according to the hue or lightness, the color reproduction range after the color region compression can be expanded, thus leading to satisfactory color reproduction.

According to another aspect of the invention in claim 7, there is provided a color converting apparatus for making color conversion by using data for color conversion generated by using the above method. Thus, since the shape of the compression function can be flexibly changed according to the hue or lightness, the color reproduction range after the color region compression can be expanded, thus leading to sufficient color reproduction.

### BRIEF DESCRIPTION OF THE DRAWINGS

FIG. 1 shows a color printing system using a color region compressing method according to the invention.

FIG. 2 shows a printer control unit.

FIG. 3 shows an image processing unit.

FIG. 4 is a color conversion unit.

FIG. 5 is a graph showing a chroma compression function according to the invention.

FIG. 6 is a diagram showing the interpolation of function parameters according to the invention.

FIG. 7 is a diagram showing the interpolation of function parameters according to the invention.

FIG. 8A is a graph showing a chroma compression function obtained by function parameters determined at point P0.

FIG. 8B is a graph showing a chroma compression function obtained by function parameters determined at point P1.

FIG. 8C is a graph showing a chroma compression function obtained by function parameters determined at point Px.

FIG. 9 shows an example of the color region compression according to the invention.

FIG. 10 is a diagram showing the comparison between a display color region and a printer color region.

FIG. 11 is a diagram showing an example of the conventional color region compression.

FIG. 12 is a graph showing an example of the conventional chroma compression function.

FIG. 13 shows another example of the conventional color region compression.

FIG. 14 shows still another example of the conventional color region compression.

FIG. 15 shows another example of the conventional chroma compression function.

### DESCRIPTION OF THE EMBODIMENTS

(Embodiment 1)

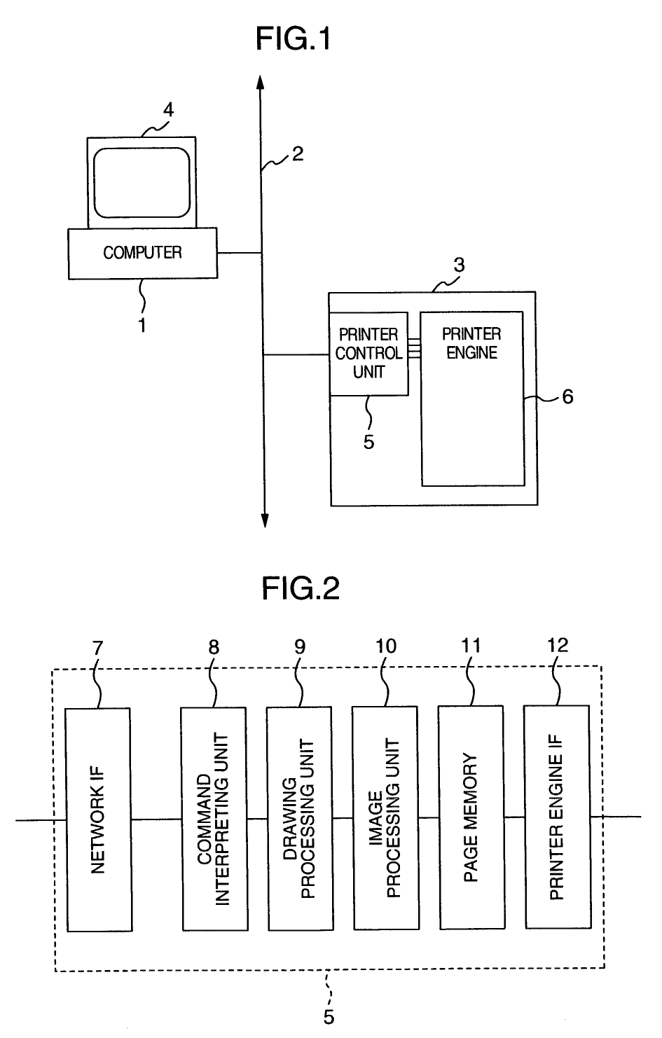

The embodiment 1 of the invention will be described with reference to FIGS. 1 to 9.

FIG. 1 shows a color printing system using a color region compressing method according to the invention.

There is shown a computer 1 which is connected through a network 2 or directly to a color printer 3. The computer 1 has a display 4 on which an image generated by the computer 1 or an image obtained by an external apparatus (not shown) can be displayed, and it sends a print command and an image data to the color printer 3 so that the image can be recorded on a paper medium by the color printer 3.

The color printer 3 is formed of a printer control unit 5 and a printer engine 6.

The printer control unit 5 interprets the command and image information sent from the computer 1 through the network 2, and expands it in an incorporated memory (not shown) as a print image of CMYK that can be printed by the print engine 6.

The printer engine 6 employs the principle of electrophotography, energizing a laser (not shown) according to the binarized CMYK signal to form a latent image on a photosensor (not shown), and develops it with toners of C (cyan), M (magenta), Y (yellow) and K (black) to transfer to paper and fix, thus producing a color print.

FIG. 2 shows the printer control unit. It includes a network IF 7, a command interpreting unit 8, a drawing processing unit 9, an image processing unit 10, a page memory 11 and a printer engine IF 12.

The print command and the image data supplied through the network IF 7 are interpreted by the command interpreting unit 8, and expanded on the incorporated memory (not shown) by the drawing processing unit 9. The image information is expanded by use of a color signal of R (red), G (green) and B (blue) of 8 bits of each pixel (hereinafter, referred to as RGB signal) that is used in the display of the computer. The expanded RGB signal is further supplied to the image processing unit 10 where it is converted to a CMYK signal for printing. This signal is stored in the page memory 11 capable of holding one-page data. After the image signal of one page is processed, the data within the page memory 11 is sent through the printer engine IF 12 to the printer engine 6.

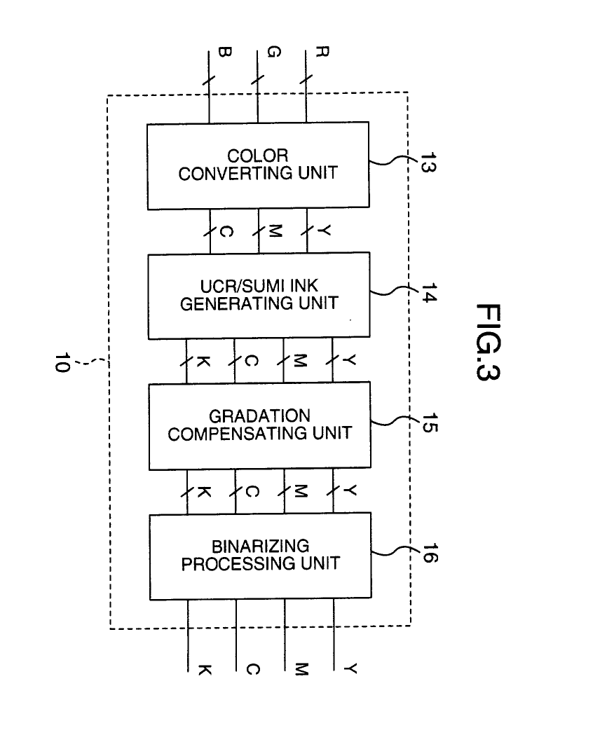

FIGS. 3 to 9 show the image processing unit 10. FIG. 3 is a diagram showing the construction of the image processing unit 10.

The image processing unit 10 has a color converting unit 13, an UCR/sumi ink generating unit 14, a gradation compensating unit 15 and a binarizing processing unit 16.

The color converting unit 13 converts the RGB signal to the CMY signal. The color converting unit 13 makes concentration conversion, and at the same time color region compression for transposing colors from the outside of the printer color region to the inside of that region.

The UCR/sumi ink generating unit 14 generates the black signal K according to the minimum value of each component of the CMY signal as in Equation (1), and reduces each component of the CMY signal as in Equation (2), thereby producing a C′M′Y′ signal (hereafter, the K signal and C′M′Y7 signal are collectively called the CMYK signal). In Equation (1), GCR (A) is a function for uniquely determining an output from input A.

K=GCR (min(C, M, Y)) (1)

C′=C−αK

M′=M−αK

Y′=Y−αK (2)

The following gradation compensating unit 15 compensates the CMYK signal according to the gradation characteristics of the printer engine 6. Since each component of the CMYK signal has 8 bits, the compensation of gradation characteristics is made by referring to a table of 256 gradations.

The binarizing processing unit 16 compares each component of the gradation-compensated CMYK signal with a threshold pattern matrix set for each color component, thereby making the binarizing processing for ON when the result is larger than the threshold and OFF when it is smaller than or equal to the threshold.

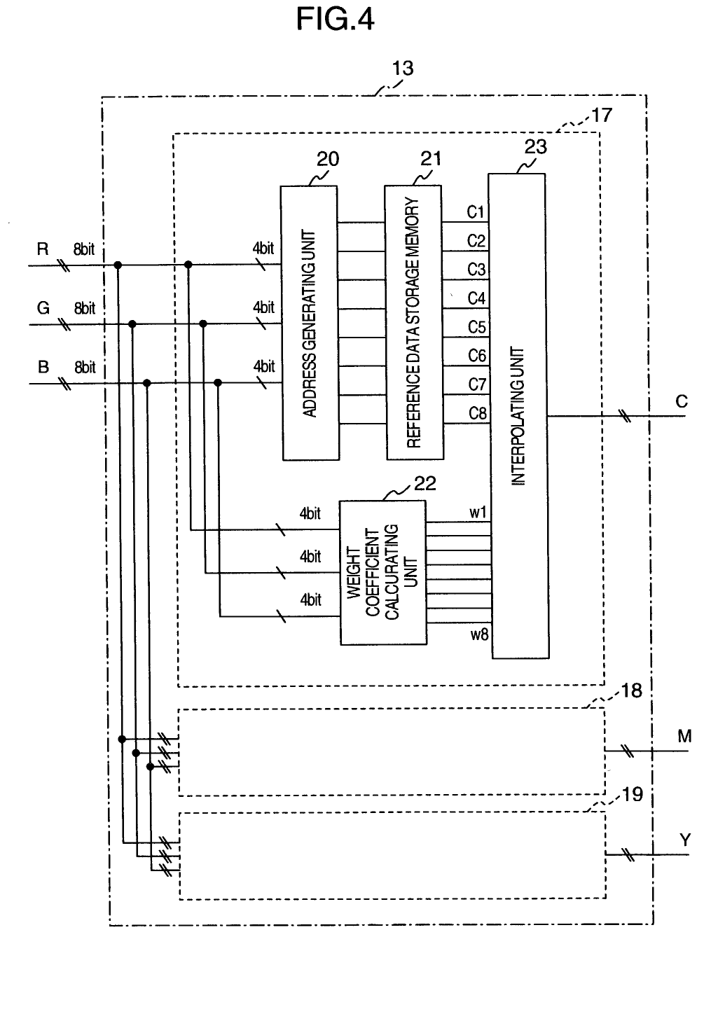

FIG. 4 shows the construction of the color converting unit 13. The respective components of the RGB signal fed to the input end are supplied to a C-signal generating unit 17, an M-signal generating unit 18 and a Y-signal generating unit 19 in parallel. The color converting unit 13 converts the RGB signal to the corresponding CMY signal, and thus needs a memory of a capacity enough to store the matching relations. However, the memory capacity becomes vast for all the relations. Thus, here, typical color matching relations are used and an arbitrary CMY signal is produced by the interpolation of those relations. The C-signal generating unit 17 has an address generating unit 20 for generating from the input RGB signal the address for use in the access to a reference data storage memory which will be described later, a reference data storage memory 21 that has stored therein conversion values by which the RGB signal can be converted to the C, M or Y, a weight coefficient calculating unit 22 for calculating from the RGB signal the weight coefficients which will be described later, and an interpolating unit 23 for calculating the output corresponding to the input RGB value by using the reference data and weight coefficients.

The operation of the color converting unit 13 will be further described in detail. The operation for determining C (cyan) from the RGB value will be first mentioned. When the more significant bits (four significant bits) of each component of the RGB signal are supplied to the address generating unit 20, the unit 20 produces eight addresses for the access to the reference data storage memory 21. At this time, the eight addresses are formed by adding 1 to the more significant bits of each component of the RGB signal. Thus, when the input RGB signal is (R0, G0, B0), the addresses thus produced correspond to the addresses in which data of coordinates are stored associated with (R1, G1, B1) to (R8, G8, B8) that surround the (R0, G0, B0) in RGB space. The data in the reference data storage memory 21 are read according to these addresses, and these data are called Ci (i is 1 to 8).

The four less significant bits of each component of the RGB signal are supplied to the weight coefficient calculating unit 22, where weight coefficients are calculated according to Equation (3). In this equation, br, bg and bb are each the four less significant bits of each component of the RGB signal.

w1=(16−br)×(16−bg)×(16−bb)

w2=br×(16−bg)×(16bb)

w3=(16−br)×bg×(16−bb)

w4=br×bg×(16−bb)

w5=(16−br)×(16−bg)×bb

w6=br×(16−bg)×bb

w7=(16−br)×bg×bb

w8=br×bg×bb (3)

The interpolating unit 23 employs the so-called cubic interpolation, calculating interpolation values from Equation (4) by substituting these CMY reference values and weight coefficients into the equation.

C=Σ(wi×Ci)/(16×16×16) (i=1 to 8) (4)

The M-signal generating unit 18 and Y-signal generating unit 19 have the same construction as the C-signal generating unit 17 except that different data are set in the reference data storage memory 21, and thus the inside components are omitted.

The reference data storage memory 21 has the C-signal (or M-signal, Y-signal) stored corresponding to the input RGB signal. That is, the previously calculated matching relations between the RGB signal and the CMY signal are stored in the memory, and these relations include the values that are set considering the color region compression from monitor color region to printer color region.

The matching relations between the RGB signal and CMY signal are generated as follows.

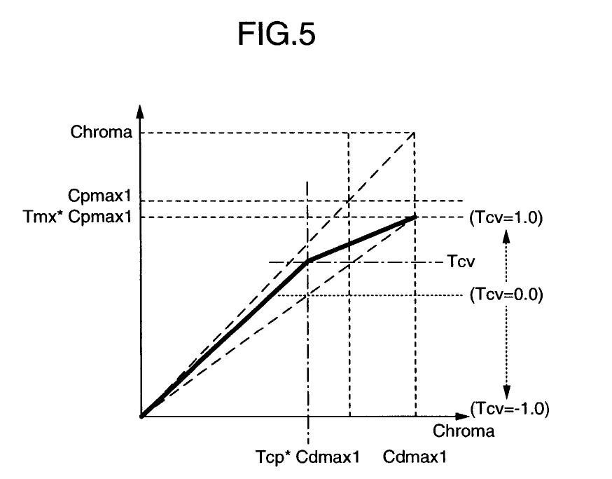

FIG. 5 shows a chroma compression function according to the invention.

When the color displayed on the monitor according to a certain RGB has lightness Ls, chroma Cs and hue Hs in the LCH color system, the chroma Cs is converted with Ls and Hs kept constant according to the function shown in FIG. 5. In the function of FIG. 5 with lightness Ls and hue Hs kept constant, the maximum chroma of the display is represented by Cdmax, and that of the printer by Cpmax. All colors having lightness Ls and hue Hs are converted to within the color reproduction region of the printer by this compression function.

This compression function has a broken-line shape fixed by three parameters of a parameter Tcp that determines the position of the bend, a parameter Tcv that determines the angle of the broken line, and a parameter Tmx that determines the maximum output. The parameter Tcp takes the normalized values of 0.0 to 1.0 derived from 0 to Cdmax, and the parameter Tmx takes the normalized values of 0.0 to 1.0 derived from 0 to Cpmax. The parameter Tcv takes 0.0 when the function exhibits the linear compression, 1.0 when the function becomes a clipping function that reaches parameter Tmx at the position of parameter Tcp, and −1.0 when the function is zero at the position of parameter Tcv.

When the color (assumed to be color 0) displayed on the monitor according to a certain RGB signal has lightness Ls0, chroma Cs0 and hue Hs0 in the LCH color system, the chroma Cs0 is converted with Ls0 and Hs0 kept constant (the chroma after conversion is assumed to be Cs0′, and the color after conversion assumed as color 0′). In addition, a color with different lightness and chroma (color 1 having lightness Ls1, chroma Cs1, and hue Hs1) is converted by use of another compression function.

The parameters that determine the shape of the function for converting the above color 0 are represented by Tcp0, Tcv0, and Tmx0, and the parameters that determine the shape of the function for converting the color 1 by Tcp1, Tcv1 and Tmx1. The shape of the function can be changed by changing these values.

Thus, by determining colors at each lightness and each hue over all the color space, it is possible to compress all colors to within the printer color region. However, when the parameters of the function are determined, it is necessary to determine the parameters at each lightness/hue while a finite number of color patches of the display and the printed results are compared with each other. Since the number of color patches is definite, these interpolation values are used for an arbitrary lightness/hue where there is no color patch.

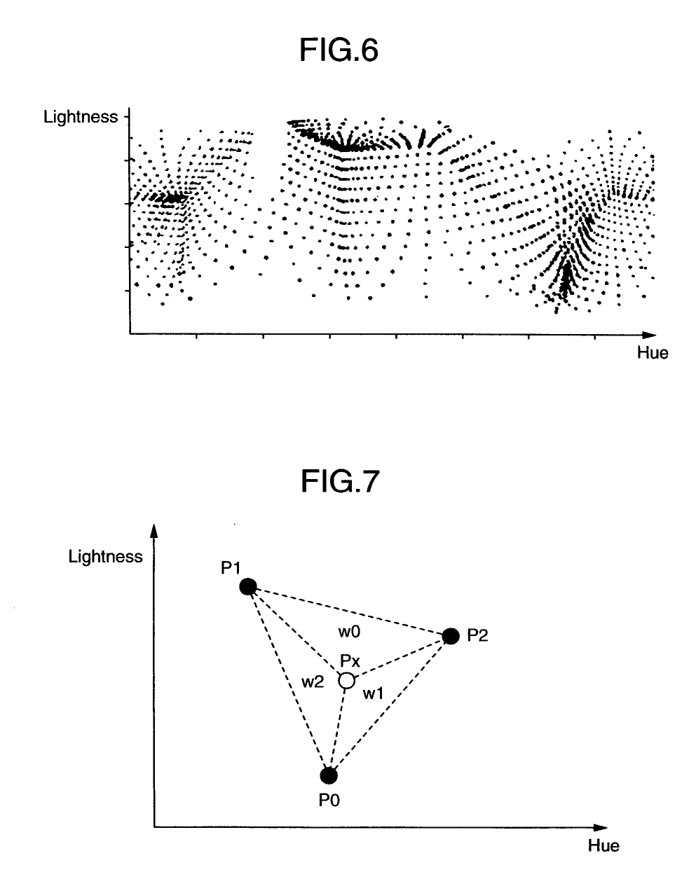

FIGS. 6 and 7 show the interpolation of function parameters according to the invention. In these figures, the abscissa indicates the hue, and the ordinate indicates the lightness. The small black circles (●) indicate the hue/lightness at which the function parameters are already set. The interpolation processing uses the function parameters at three hue/lightness points (P0, P1, P2) that surround a desired hue/lightness point (Px). When the function parameters at the desired hue/lightness Px are represented by Tcpx, Tcvx and Tmxx, the function parameters at Pn (n is 0 to 2) by Tcpn, Tcvn and Tmxn, and the positional relation of Px and Pn are shown in FIG. 7, then Tcpx, Tcvx and Tmxx are calculated from Equation (5).

Tcpx=(Σwn·Tcpn)/Σwn

Tcvx=(Σwn·Tcvn)/Σwn

Tmxx=(Σwn·Tmxx)/Σwn (5)

Where wn is the area of each of the three triangles formed by drawing a straight line from Px to each apex Pn in the triangle P0, P1, P2 of FIG. 7. The suffix n of wn represents the triangle positioned opposite to the direction from Px to Pn.

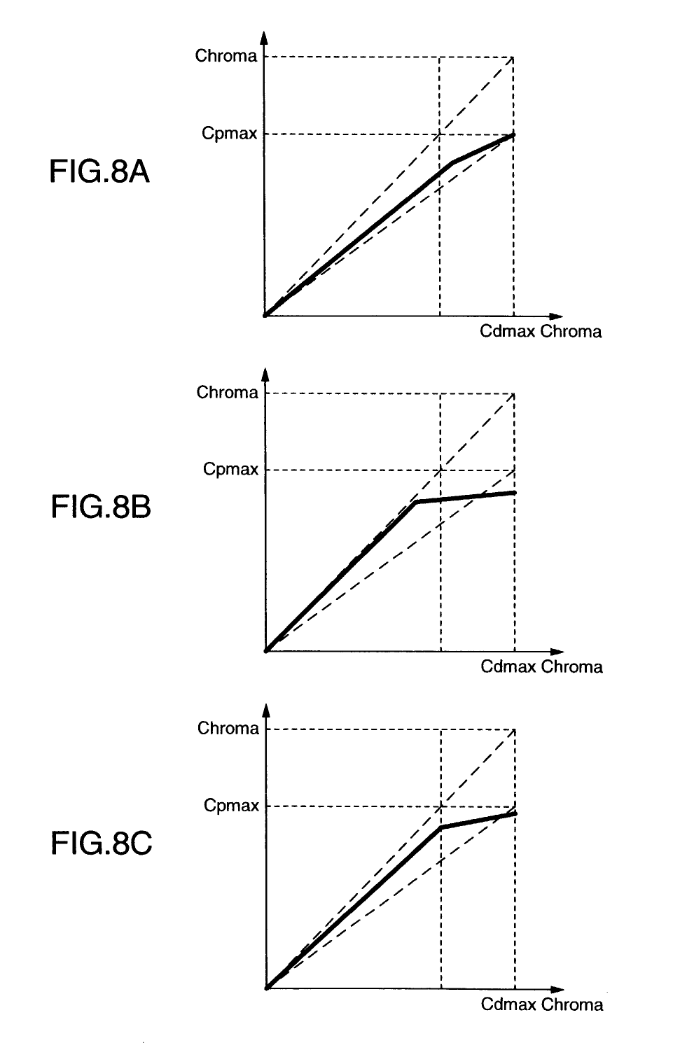

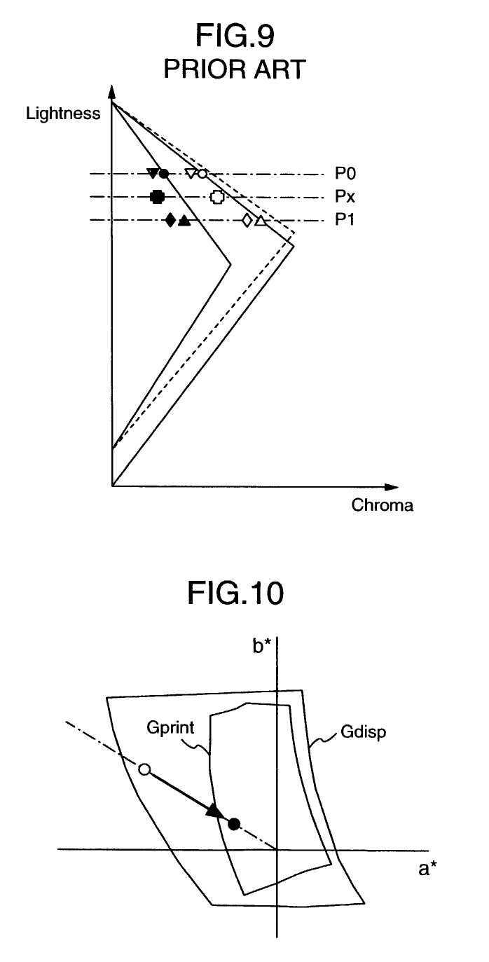

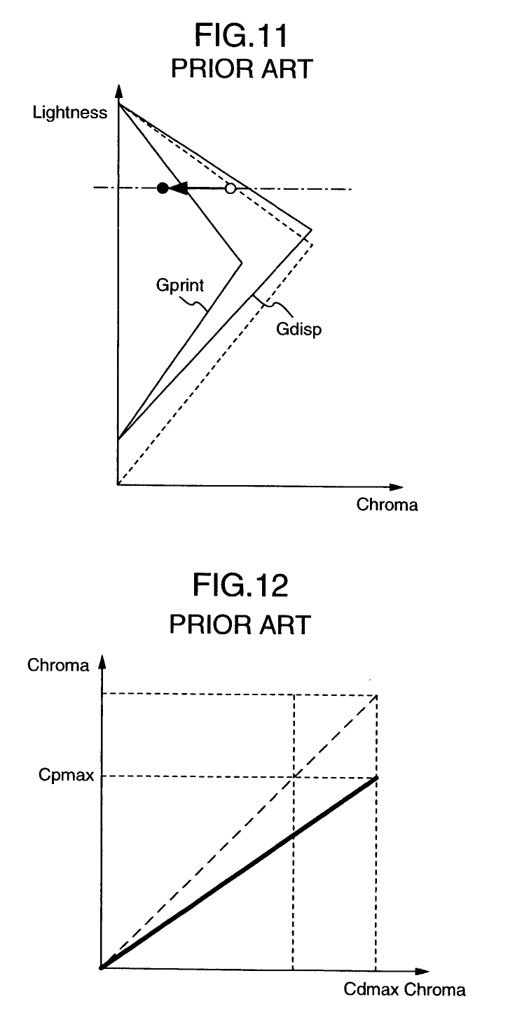

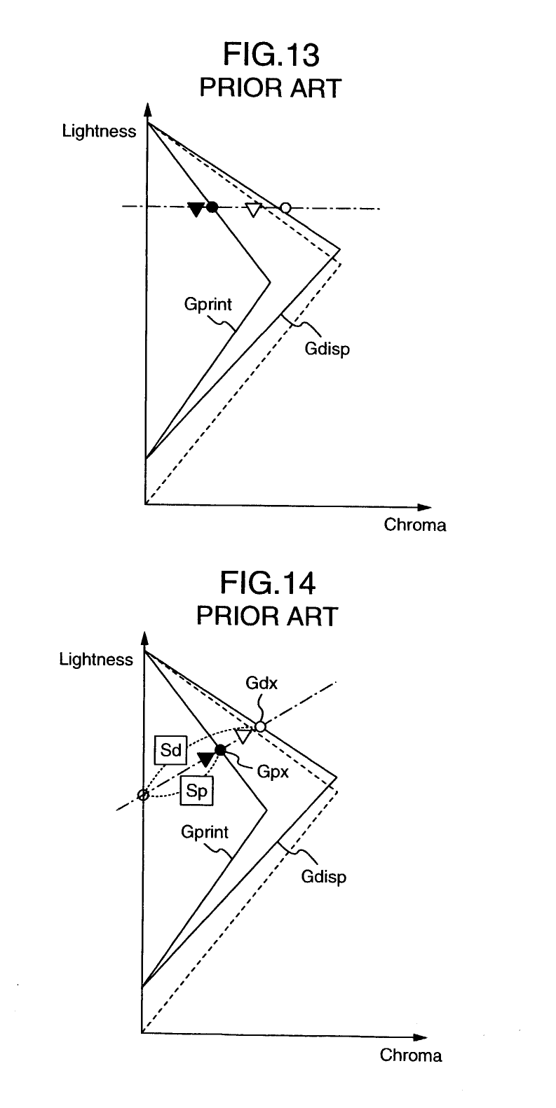

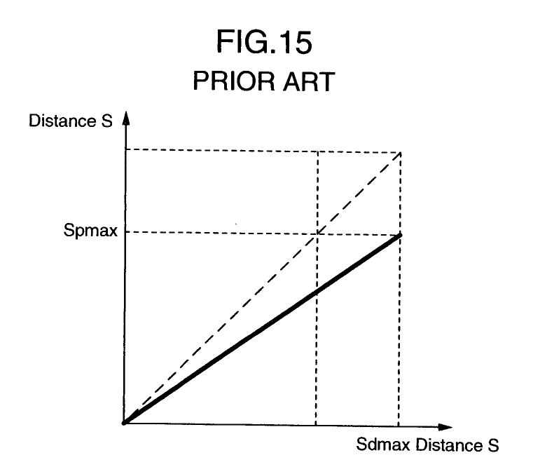

FIGS. 8A-8C and 9 show examples of the color region compression according to the invention.

FIGS. 8A-8C show examples of the chroma compression function according to the invention. For the sake of simplicity, it is assumed that the points P0, P1 and Px are in the same hue and that the point Px is located between the points P0 and P1. In this case, w2=0, and interpolation is made only between the two points P0 and P1. FIG. 8A shows the chroma compression function obtained by the function parameters previously determined at point P0, FIG. 8B shows the chroma compression function by the function parameters previously determined at point P1, and FIG. 8C shows the chroma compression function by the function parameters that are determined by interpolation at point Px.

FIG. 9. shows one example of the color region compression according to the invention. Color region compression is made by the color region compression function according to the invention so that the color of the outline figures (∘, ▾, ∇. . . ) becomes that of the black figures (●, ▴, ▾. . . ). The points P0, P1 of lightness are respectively compressed according to the compression functions of FIGS. 8A and 8B, and the point Px of lightness is compressed according to the compression function that is generated by the function parameters interpolated as shown in FIG. 8C. Thus, the color compression function can be changed at an arbitrary hue/lightness so that full color reproduction can be made by expanding the range of color region compression.

While the color signal is converted from RGB to CMY in the above embodiment, the input signal may be expressed by another color coordinate system such as Lab, XYZ. Also, the signal after conversion may be the CMYK signal or of any signal type to comply with other color materials for use with the printer engine.

While the shape of the color region compression function is a broken line in this embodiment, it may be any function defined by parameters that can determine the saturation point and nonlinearity of the compression function.

In addition, while the color converting unit makes conversion by referring to a table and by use of the interpolation in this embodiment, a computer may be used to sequentially calculate.

Moreover, while the color region compression is made for only the chroma with hue and lightness kept constant in this embodiment, the present invention is not limited to this method, but may use a function by which the lightness and chroma can be compressed at the same time, which was described in the prior art section.

Thus, as described above, a color region compressing method according to the first aspect of the invention in claim 1 is provided for compressing the lightness and/or chroma of an input color to within an output color reproduction region, this method including the steps of determining by function parameters the compression function for compressing the lightness and/or chroma of the input color to within the output color reproduction region, and changing the function parameters in the hue direction and/or lightness direction of the color. Thus, since the shape of the compression function can be flexibly changed according to the hue or lightness, the color reproduction range after the color region compression can be expanded, thus leading to enough color reproduction.

1. A color region compressing method for converting a lightness and/or a chroma of an input color to within an output color reproduction region, comprising the steps of:
determining by function parameters a compression function for compressing the lightness/chroma of the input color to within the output color reproduction region; and
changing the function parameters according to hue and/or lightness.

2. A method according to claim 1, wherein said function parameters are determined for N points (N being an integer of 1 and above) where said hue and/or lightness differs, and the function parameters for other points different from said N hue and/or lightness points are determined by interpolation between said function parameters for said N points.

3. A method according to claim 1, wherein said function parameters include a parameter for expressing a gradient of the function.

4. A method according to claim 1, wherein said function parameters include a parameter for determining a magnitude of a saturation point of the function.

5. A method according to claim 1, wherein said function parameters include a parameter for expressing a degree of nonlinearity of the function.

6. A color converting apparatus for making color conversion by using said color region compressing method according to claim 1.

7. A color converting apparatus for making color conversion by using data for color conversion generated by using said color region compressing method according to claim 1.
